(19) United States
(12) Patent Application Publication
(10) Pub. No.: US 2019/0311391 A1
(43) Pub. Date: Oct. 10, 2019

(54) SYSTEM AND METHOD FOR LINKING CONSUMERS AND MERCHANTS IN AN INTERCONNECTED ENVIRONMENT

(71) Applicant: Tommy Dewayne Lambright, Austin, TX (US)

(72) Inventor: Tommy Dewayne Lambright, Austin, TX (US)

(21) Appl. No.: 16/375,004

(22) Filed: Apr. 4, 2019

Related U.S. Application Data
(60) Provisional application No. 62/652,770, filed on Apr. 4, 2018.

(51) Int. Cl. G06Q 30/02

(52) U.S. Cl. CPC G06Q 30/0226; G06Q 30/0236

(57) ABSTRACT

The embodiments herein provide program, system and method for linking consumers and merchants in a marketing program. Accordingly, a marketing method for linking consumers and merchants in an inter-connected environment, the method comprising steps of receiving a request from a merchant outlet for entering membership with a club providing membership, registering a merchant member associated with the merchant outlet and creating a merchant member record, receiving a request from a consumer for entering membership with the club providing membership, the consumer being associated with the merchant member, registering a consumer member and creating a member record, the consumer member being associated with the merchant member, generating a membership identification for the consumer member so as to enable the consumer member for eligible discounts available in one or more merchant member outlets and crediting a revenue sharing amount to the merchant member by the club on a recurring basis.

### BACKGROUND

### Technical Field

The embodiments herein generally relate to methods of managing consumer rewards and incentives and more particularly to a system promoting links between community programs, consumers, merchants, members and possibly intermediaries.

### Description of the Related Art

Consumers are always looking for the best deals on items and discounts given by vendors/merchants or companies. Consumers sign up for memberships at various companies based on their benefits and promotions. Access to a database of companies that offer discounts could lead more consumers to sign up for memberships and programs and lead to increased sales for those companies. However, there are no platforms that link restaurant/bars as well as other various merchants with consumers.

On the other hand, several systems presently exist that provide reward points or discounts to customers. Most of these are set-up as loyalty systems whereby a loyalty card or number is provided to a customer. A customer may gain reward points when a transaction occurs and the loyalty card or number is provided at the point of the transaction. Accumulated reward points can be redeemed for products, discounts, or other rewards. Such loyalty systems are provided directly by a merchant or by an organization representing one or more merchants.

However, there are no marketing programs for linking consumers and merchants beyond loyalty programs in an interconnected environment in order to encourage additional revenue for merchants.

Hence, there is a need for linking consumers and merchants that provides access to various discount programs offered in an interconnected environment that is beneficial both for customers and merchants.

The abovementioned shortcomings, disadvantages and problems are addressed herein and which will be understood by reading and studying the following specification.

### OBJECT OF THE EMBODIMENTS HEREIN

The primary object of the embodiments herein is to link merchants and consumers for various discount programs offered by merchant members.

Another object of the embodiments herein is to provide a platform for merchants so as to provide better visibility resulting in increased consumer seek outs.

Yet another object of the embodiments herein is to provide a platform for merchants to receive additional exposure though advertising campaigns conducted by the club providing membership.

Yet another object of the embodiments herein is to provide a platform for merchants to receive additional revenue through revenue sharing program conducted by the club providing membership.

Yet another object of the embodiments herein is to provide a platform for consumers to access ready information available on discounts offered by merchant members.

Yet another object of the embodiments herein is to provide a platform for consumers to choose from a pool of merchant members thereby providing access to variety of discounted products and services.

Yet another object of the embodiments herein is to provide equal opportunities to all merchant members to earn additional revenue.

Yet another object of the embodiments herein is to provide a platform for all the consumer members to introduce them to a community program, where the value of the reward is many times larger than the traditional loyalty program.

Yet, another object of the embodiments herein is to provide a consumer loyalty marketing program that can be operated on a global basis.

These and other objects and advantages of the embodiments herein will become readily apparent from the following summary and the detailed description taken in conjunction with the accompanying drawings.

### SUMMARY

The following details present a simplified summary of the embodiments herein to provide a basic understanding of the several aspects of the embodiments herein. This summary is not an extensive overview of the embodiments herein. It is not intended to identify key/critical elements of the embodiments herein or to delineate the scope of the embodiments herein. Its sole purpose is to present the concepts of the embodiments herein in a simplified form as a prelude to the more detailed description that is presented later.

The other objects and advantages of the embodiments herein will become readily apparent from the following description taken in conjunction with the accompanying drawings.

The various embodiments herein provide program, system and method for linking consumers and merchants in a marketing program.

According to an embodiment herein, a marketing method for linking consumers and merchants in an inter-connected environment, the method comprising steps of receiving a request from a merchant outlet for entering membership with a club providing membership, registering a merchant member associated with the merchant outlet and creating a merchant member record, receiving a request from a consumer for entering membership with the club providing membership, the consumer being associated with the merchant member, registering a consumer member and creating a member record, the consumer member being associated with the merchant member, generating a membership identification for the consumer member so as to enable the consumer member for eligible discounts available in one or more merchant member outlets and crediting a revenue sharing amount to the merchant member by the club on a recurring basis.

According to another embodiment herein, a marketing system for promoting one or more merchants and the products and services of the one or more merchants in an inter-connected environment, comprising: one or more data storage devices and at least one processor configured for receiving a request from a merchant outlet for entering membership with a club providing membership, registering a merchant member associated with the merchant outlet and creating a merchant member record, receiving a request from a consumer for entering membership with the club providing membership, the consumer being associated with the merchant member, registering a consumer member and creating a member record, the consumer member being associated with the merchant member, generating a membership identification for the consumer member so as to enable the consumer member for eligible discounts in one or more merchant member outlets and crediting a revenue sharing amount to the merchant member by the club on a recurring basis.

According to yet another embodiment herein a computer program product storing computer readable instructions, which when executed cause a processor to perform a method comprising the steps of receiving a request from a merchant outlet for entering membership with a club providing membership, registering a merchant member associated with the merchant outlet and creating a merchant member record, receiving a request from a consumer for entering membership with the club providing membership, the consumer being associated with the merchant member, registering a consumer member and creating a member record, the consumer member being associated with the merchant member, generating a membership identification for the consumer member so as to enable the consumer member for eligible discounts available in one or more merchant member outlets and crediting a revenue sharing amount to the merchant member by the club on a recurring basis.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a block diagram depicting a marketing system for promoting one or more merchants and the products and services of the one or more merchants in an inter-connected environment, as described in one embodiment of the invention.

FIG. 2 illustrates a flow diagram depicting a marketing method for linking consumers and merchants in an inter-connected environment, as described in one embodiment of the invention.

Although the specific features of the embodiments herein are shown in some drawings and not in others. This is done for convenience only as each feature may be combined with any or all of the other features in accordance with the embodiment herein.

### DETAILED DESCRIPTION OF THE EMBODIMENTS HEREIN

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

In the following detailed description, a reference is made to the accompanying drawings that form a part hereof, and in which the specific embodiments that may be practiced is shown by way of illustration. The embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide program, system and method for linking consumers and merchants in a marketing program.

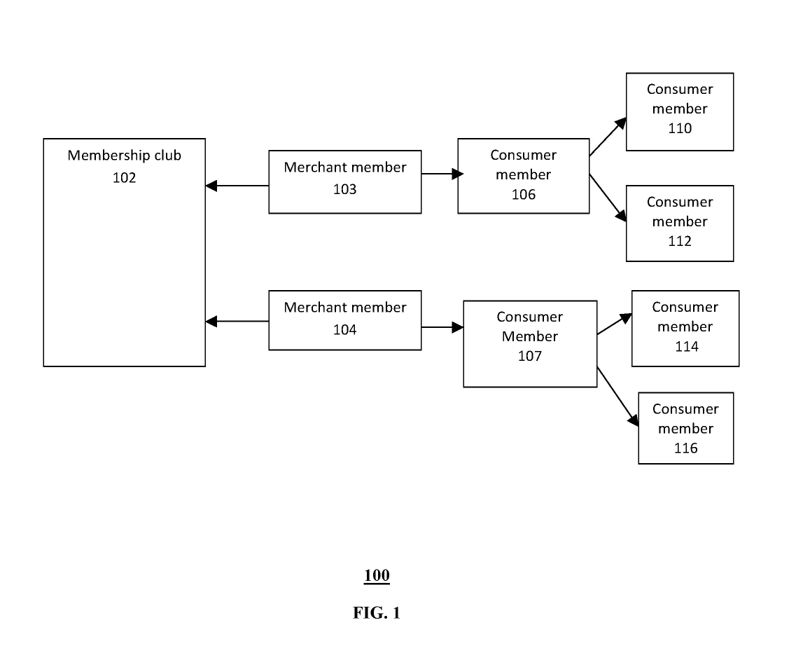

Turning now to figures, FIG. 1 illustrates a block diagram depicting a marketing system 100 for promoting one or more merchants and the products and services of the one or more merchants in an inter-connected environment, as described in one embodiment of the invention.

The marketing system 100 includes a membership club 102 that is offering membership. The membership offered are typically of two types namely a merchant membership and a consumer membership. A merchant associated with a merchant outlet and who is requesting merchant membership is registered by the membership club thereby creating a merchant member 103 record. A merchant is an owner of a restaurant, bar, eatery or any establishment that offers product and/or services to a consumer. A merchant associated such with a merchant outlet such as restaurant, bar or any brick and mortar outlet offering a product or a service for consumption.

A consumer member 106 is a connoisseur of food and drinks who is interested in consuming the product and/or services offered by the merchant members 104 and 103 enrolled for the club membership.

In an exemplary embodiment, restaurant, bars and other retail outlets can become affiliate establishments of the club by entering into a contract to give the consumer members 106 the discounts agreed upon.

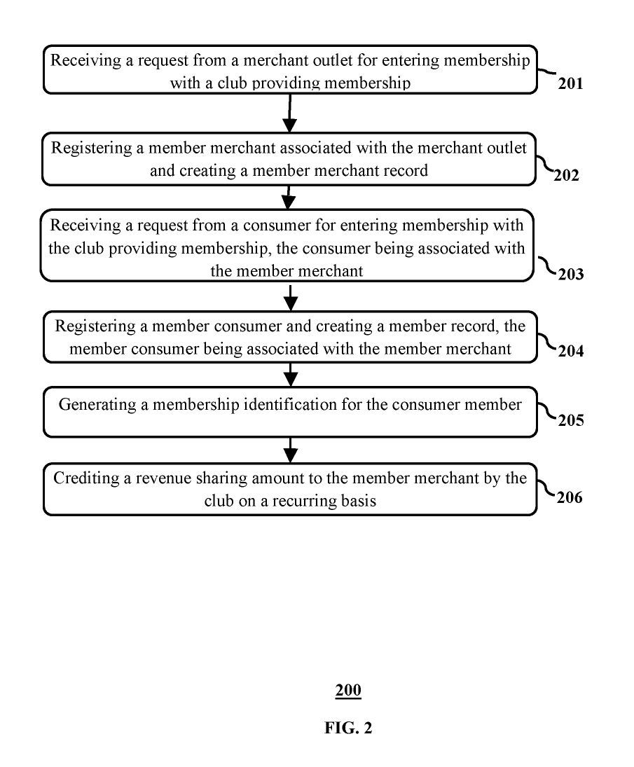

The marketing system 100 disclosed herein is configured to link both the consumer members 106 and the merchant members 103 using a mobile application which is further explained in conjunction with FIG. 2.

Consumers can download the mobile application through operating systems including but not limited to iOS, Windows or Android that will allow them to find restaurants, bars, or other merchants where the consumer can go and receive discounts off of their entrees and alcohol, where permitted by law, or other kinds of discounts which merchants are willing to offer to consumers.

The membership club steadily adds restaurants/bars and other types of merchants across the globe that will honor these memberships and give discounts to their consumer-base when they show their membership identification using the mobile application.

Through FIG. 1 shows merchant members 103 and 104 and consumer members 106 and 107, skilled artisans shall appreciate that in practice the number of these may run into several thousands.

A merchant member's 103 share of revenue is received from each consumer member 106 associated with the merchant member 103. Accordingly, a mapping of the membership identification of the merchant member 103 with membership identification of each consumer member 106 associated with the merchant member 103 may be maintained in the database.

Further, each consumer member 106 and 107 may recruit additional consumer members 110, 112 and 114, 116 who will be associated with the merchant member 103 and 104 respectively of the recruiting consumer member 106 and 107. The merchant member 103 accordingly receives a part of the predetermined recurring payment made by each additional consumer member 110, 112 and 114, 116 respectively, recruited by the consumer member 106 directly associated with the merchant member 103.

Further, the consumer member 106 may be suitably incentivized for recruiting each additional consumer member 106. Alternatively, the incentive may be deducted from the membership fee that is to be paid by the consumer member 106. In a scenario where a predetermined number of additional members are recruited, the consumer member 106 may be exempted from paying the membership fee.

According to an embodiment herein, as shown in FIG. 2, a marketing method 200 for linking consumers and merchants in an inter-connected environment is disclosed. The method 200 comprises steps of receiving a request from a merchant outlet for entering membership with a club providing membership (at step 201), registering a merchant member 103 associated with the merchant outlet and creating a merchant member 103 record (at step 202), receiving a request from a consumer for entering membership with the club providing membership (at step 203), the consumer being associated with the merchant member 103, registering a consumer member 106 and creating a member record (at step 204), the consumer member 106 being associated with the merchant member 103, generating a membership identification for the consumer member 106 so as to enable the consumer member 106 for eligible discounts available in one or more merchant member 103 outlets (at step 205) and crediting a revenue sharing amount to the merchant member 103 by the club on a recurring basis (at step 206).

The method 200 includes receiving a predetermined payment on a recurring basis from each consumer member 106 enrolled at the club providing membership. This recurring predetermined payment may be termed as membership fee or member ship due that may be paid once a month for example. A part of this recurring payment may be credited to the merchant member 103 associated with the consumer member 106.

The method 200 further includes tracking the number of consumer members 106 associated with a merchant member 103 and crediting the additional revenue earned by the merchant member 103 accordingly.

Further, the method 200 is incorporated as a mobile application installed on a user device. Applications, as used herein, include any set of computing instructions. Applications instruct an electronic device to perform specified functions. Applications typically contain logic and methods for accessing, manipulating, and storing data. Applications also contain instructions on displaying and formatting data. For example, an application is configured to instruct an electronic device to access certain data and display it in a specified format and/or at a specified time.

Applications are sent through any method suitable for such purpose. For example, the applications are downloaded to the user device through a Web browser or sent to the user device using a “push” type operation via a network protocol over a cable or wireless infrastructure. Possible means for pushing an application or application reference include, but are not limited to, email, embedding in a Web page, part of an RSS feed, a WAP™. push, or a Bluetooth™ transmission. The system for deploying applications to the user devices optionally includes a runtime environment for the application. A runtime environment is software that allows a user device to execute application code.

According to another embodiment herein, the marketing system 100 for promoting one or more merchants and the products and services of the one or more merchants in an inter-connected environment, comprises one or more data storage devices and at least one central server configured for performing the method of FIG. 2.

The central server is configured for storing, processing and providing information to a user. For this purpose, the central server may include memory, a processor and a communication unit. The processor may be a general purpose processor, a Field Programmable Gate Array (FPGA), an Application Specific Integrated Circuit (ASIC), a Digital Signal Processor (DSP), and/or the like. The processor may be configured to retrieve data from and/or write data to the memory. The memory may be, for example, a random access memory (RAM), a memory buffer, a hard drive, a database, an erasable programmable read only memory (EPROM), an electrically erasable programmable read only memory (EEPROM), a read only memory (ROM), a flash memory, a hard disk, a floppy disk, cloud storage, and/or so forth. In one embodiment, the server may include one or more hardware-based units (e.g., DSP, FPGA, ASIC) and/or software-based units (e.g., a unit of computer code stored at the memory and executed at the processor, a set of processor-readable instructions that may be stored at the memory and executed at the processor) associated with executing an application, such as, for example, receiving, processing and displaying data from the user devices.

Further, the central server may include a database (e.g., in memory and/or through a wired and/or a wireless connection) for storing data received from various user devices.

Any database discussed herein may include relational, hierarchical, graphical, or object-oriented structure and/or any other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), MySQL, or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art.

The central server is further configured for hosting a web page for accessing data related to the database. The web page may be accessed using the one of the user interface (not shown) at the central server and at the user device.

The web page may be employed for advertising one or more product and/or services offered by each merchant member 103. The advertisement may further include the discounts currently on offer, incentive scheme, additional rewards or loyalty programs offered by a merchant member 103. Further, the advertisement may be directed to one or more targeted consumer members 106 who are likely to benefit from the offer.

The advertisement may be visible to a consumer member 106 soon upon logging into the web page or through push notifications using social media. Alternatively, such advertisements may be communicated to an identified member and/or other potential consumers by a variety of online and offline means, including a webpage, an email, a communication sent to a mobile device, a print advertisement, a radio advertisement, etc.

The embodiments of the invention include a computer-readable medium encoded for computer-execution of prediction of policies embodiment of FIG. 1. Program logic embodied on computer-readable medium is encoded in computer-executable code configured for carrying out the prediction of the policies and other aspects of the present invention described herein and thereby forms a computer program product.

The methods and apparatus of this invention may take the form, at least partially, of program code (i.e., instructions) embodied in tangible media, such as floppy diskettes, CD-ROMs, hard drives, random access or read only-memory, or any other machine-readable storage medium. When the program code is loaded into and executed by a machine, such as a computer, the machine becomes an apparatus for practicing the invention. The methods and apparatus of the present invention may also be embodied in the form of a program code, which when received and loaded into and executed by a machine, such as a computer, the machine becomes an apparatus for practicing the invention. When implemented on one or more general-purpose processors, the program code combines with such a processor to provide a unique apparatus that operates analogously to specific logic circuits. As such a general purpose digital machine can be transformed into a special purpose digital machine.

The functions described herein are implemented in hardware, software executed by a processor, firmware, or any combination thereof. If implemented in software executed by a processor, the functions are stored on or transmitted over as one or more instructions or code on a computer-readable medium. Other examples and implementations are within the scope and spirit of the disclosure and appended claims. For example, due to the nature of software, functions described above is executed using software executed by a processor, hardware, firmware, hardwiring, or combinations of any of these. Features implementing functions may also be physically located at various positions, including being distributed such that portions of functions are implemented at different physical locations.

The advantages of the embodiments disclosed herein comprise linking merchants and consumers for various discount programs offered by merchant members. The invention provides a platform for merchants to receive additional exposure though advertising campaigns conducted by the club providing membership.

Further, the invention provides a platform for merchants to receive additional revenue through revenue sharing program conducted by the club providing membership.

The invention provides a platform for all the consumer members to introduce them to a community program, where the value of the reward they receive is many times larger than the traditional loyalty program.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the appended claims.

It is also to be understood that the following claims are intended to cover all of the generic and specific features of the embodiments described herein and all the statements of the scope of the embodiments which as a matter of language might be said to fall there between.

What is claimed is:

1. A marketing method for linking consumers and merchants in an inter-connected environment, the method comprising steps of:
receiving a request from a merchant outlet for entering membership with a club providing membership;
registering a merchant member associated with the merchant outlet at a central server and creating a merchant member record;
receiving a request from a consumer for entering membership with the club providing membership, the consumer being associated with the merchant member;
registering a consumer member and creating a member record at the central server, the consumer member being associated with the merchant member;
generating a membership identification for the consumer member so as to enable the consumer member for eligible discounts available in one or more merchant member outlets; and
crediting a revenue sharing amount to the merchant member by the club on a recurring basis.

2. The marketing method as claimed in claim 1, further comprising:
generating a membership identification for the merchant member
receiving information on a transaction account associated with the merchant for enabling financial transaction; and
mapping the member identification of the merchant member with the transaction account of the merchant member.

3. The marketing method as claimed in claim 2, wherein the transaction account is one of a mobile wallet or bank account.

4. A marketing system for promoting one or more merchants and the products and services of the one or more merchants in an inter-connected environment, comprising: one or more data storage devices and at least one processor configured for
receiving a request from a merchant outlet for entering membership with a club providing membership;
registering a merchant member associated with the merchant outlet at a central server and creating a merchant member record;
receiving a request from a consumer for entering membership with the club providing membership, the consumer being associated with the merchant member;
registering a consumer member and creating a member record at the central server, the consumer member being associated with the merchant member;
generating a membership identification for the consumer member so as to enable the consumer member for eligible discounts in one or more merchant member outlets; and
crediting a revenue sharing amount to the merchant member by the club on a recurring basis.

5. The marketing system of claim 1, wherein the processor is further configured for:
generating a membership identification for the merchant member
receiving information on a transaction account associated with the merchant for enabling financial transaction; and
mapping the member identification of the merchant member with the transaction account of the merchant member.

6. A computer program product storing computer readable instructions, which when executed cause a processor to perform a method comprising the steps of:
receiving a request from a merchant outlet for entering membership with a club providing membership;
registering a merchant member associated with the merchant outlet at a central server and creating a merchant member record;
receiving a request from a consumer for entering membership with the club providing membership, the consumer being associated with the merchant member;
registering a consumer member and creating a member record at the central server, the consumer member being associated with the merchant member;
generating a membership identification for the consumer member so as to enable the consumer member for eligible discounts available in one or more merchant member outlets; and
crediting a revenue sharing amount to the merchant member by the club on a recurring basis.
